(19) United States
(12) Patent Application Publication
(10) Pub. No.: US 2007/0026775 A1
(43) Pub. Date: Feb. 1, 2007

(54) Squid shaped crab claw cracker

(76) Inventor: Todd Seiple, San Diego, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/479,550

(22) Filed: Jun. 30, 2006

Related U.S. Application Data
(60) Provisional application No. 60/695,694, filed on Jun. 30, 2005.

(51) Int. Cl. A22C 29/02

(52) U.S. Cl. 452/6

(57) ABSTRACT

A squid shaped crab claw cracker that is used for cracking the shells of a crab claw and for extracting the meat from the claw. The squid shaped crab claw cracker includes a base; a first leg mounted to the base at one end and proceeding outward therefrom; a second leg, pivotally mounted to the base at one end and proceeding outward therefrom; and a meat extractor, mounted to the base and extending perpendicularly outward therefrom.

### CROSS REFERENCE TO A RELATED APPLICATION

This application claims benefit to provisional application No. 60/695,694, filed on Jun. 30, 2006, entitled “Squid Shaped Crab Claw Cracker”, which is incorporated herein by reference in its entirety.

### FIELD OF THE INVENTION

The present invention relates to crab claw crackers and in particular, a squid shaped crab claw cracker.

### BACKGROUND OF THE INVENTION

Given the desire for people to eat healthier diets, seafood has become a common staple in a healthy diet. Many types of seafood can be eaten as is; however, some of the healthy seafood such as lobster, shrimp, crab, and the like require a person to remove the shell in order to extract the meat from the shell. For this purpose, a variety of crackers have been introduced to aid restaurants and diners in extracting seafood meat from the shell.

U.S. Pat. No. 5,613,904 is directed toward a utensil which is provided for facilitating the opening and removing the meat from crab legs or other types of shellfish. The utensil has an elongated handle portion and a bifurcated head section joined to the handle portion and provided with separate elongated first and second tine segments disposed in spaced, directly opposed, generally parallel relationship with the space there between being no greater than about twice the normal thickness of the shell of the shellfish. The first tine segment has a relatively wide planar surface facing a relatively narrow, toothed surface of the second tine segment. The second tine segment is of greater length than the first tine segment. The outermost end of the first tine segment is provided with a beveled shell-guiding face which serves as a fulcrum surface and extends in a direction toward the teeth of the second tine segment for facilitating direction of the shell into contact with the teeth during successive up and down manipulations of the utensil to effect opening of the shellfish shell. The toothed second tine is first slipped under the shell of the shellfish and the utensil oscillated up and down as it is forced forwardly whereby the toothed surface supported by the fulcrum point of the outer end of the first fine segment functions to sever the shell and expose the meat for ready removal.

U.S. Pat. No. 5,586,931 is directed toward a hand held utensil which is adapted to open elongate sections of crab leg shells and similar objects comprising a manually engagable handle, a planar blade secured to the handle and extending outwardly to a tip, with the forward portion of the blade adjacent the tip being substantially straight. A blade-protecting member is secured in a spaced relationship adjacent the substantially straight forward portion of the blade, with the blade-protecting member extending from the handle for a distance exceeding the length of the blade. An open-ended slot is defined between the substantially straight forward blade portion and the blade-protecting member, with such slot being adapted to receive the shell of a crustacean, such that the blade can cut through the shell as a user grasping the handle moves the blade longitudinally along the shell. In the preferred embodiment, the blade is multiangled, with a rear portion of the blade extending upwardly from the substantially straight forward blade portion in the direction of the adjacent undersurface of the blade-protecting member. The undersurface of latter member has a recess therein into part of which the upwardly extending rear blade portion extends, thus to provide assured shell-cutting capability when the blade and recess are brought into contact with a crustacean shell. The rear portion of the multiangled blade may extend up smoothly from the substantially straight, forward most portion of the blade, or it may form an obtuse angle with the substantially straight forward most portion of the blade.

U.S. Pat. No. 5,403,230 is directed toward a device for opening the shells of crustaceans that have an inner portion and an outer portion extending from a handle section at one end to a cutting section at the other end. In the cutting section, the inner portion has a sharpened end at the start of a cutting or fracturing edge that tapers upward toward the handle. The cutting section of the outer portion has sides that taper downward on each side of the cutting edge toward the handle, overlapping the cutting edge about halfway down. The outer portion fits loosely over the inner portion, to be removable for cleaning etc. The inner portion cutting edge thickens as it tapers upward for increased strength in cutting harder shells, and the sides of the outer portion cutting section become fulcrums when the handle is raised to lever the cutting edge of the inner portion through the crustacean's shell to expose the shellfish meat.

U.S. Pat. No. 5,947,808 is directed toward an apparatus and method for removing skin, membranes, bones, cartilage, antennae, legs, shell, beard and/or veins from seafood prior to, during and/or after the seafood is cooked. The apparatus generally having: (a) measuring means for locating bones within the seafood; (b) cutting means for separating the skin, membrane, bone, cartilage, antennae, legs, shell, beard or vein from the seafood; and (c) pinching means for gripping and removing the skin, membrane, bone, cartilage, antennae, legs, shell, beard or vein from the seafood. The apparatus may further comprise such elements as, but not limited to: (d) handle means for holding and manipulating the measuring means, cutting means, or pinching means during use of the apparatus; (e) gripping means for enhancing the ability to securely grip the handle means during use thereof; and/or (f) means for selectively removing the cutting means from the handle means for easy cleaning thereof.

U.S. Design Pat. No. D491,781 is directed toward the ornamental design for crustacean pliers.

U.S. Pat. No. 6,390,911 is directed toward a shell seafood cracking and serving device for cracking shell seafood with little mess and effort by the user. The shell seafood cracking and serving device includes a utensil having a handle member and a seafood cracking member being securely attached at an end of the handle member.

U.S. Pat. No. 6,019,673 is directed toward a utensil for cracking the shells of crabs, lobsters, and other shellfish. A pair of handles are pivotally connected, each handle having a jaw with a tapered cutting edge for cracking the shells without severing the meat which the shells contain. The handles are bent in such a way as to prevent complete closure of the jaws, so that the shell is cracked while leaving the meat of the shellfish intact. This construction also facilitates using the bent ends of the handles for extracting the meat from the cracked shell. For this purpose the bent ends of the handles are beveled, and taper from wide to narrow in a direction away from their jaws and toward their free ends. When the crab cracker is ready for storage, the bent handles are locked by forcing them apart and placing them in a parallel position. This enables the crab cracker to be easily and neatly stored in a minimum of space.

U.S. Patent Publication No. 2004/0242139 is directed toward a utensil for removing the shell from the body of a crustacean prior to consumption. The utensil comprises of a body having a leading end and a trailing end, the leading end includes a leading end tip capable of engaging the crustacean between an underside of a shell and opposing body surface of the crustacean. The leading end comprises of contoured portions co-operate with the leading end tip to lift and separate said shell from said crustacean body. The trailing end comprises of a handle which allows a user to urge the utensil longitudinally of the body so the shell is separated in one pass along spine.

There continues to be a need; however, for a squid shaped crab claw cracker which can be used to crack crab claws and extract the meat from the claws. The above patents do not disclose a device that solves such a need. It is a further aspect of the present invention to create the crab claw cracker to be squid shaped to enhance the enjoyment of the utensil.

### SUMMARY OF THE INVENTION

In accordance, the present invention is a novel squid shaped crab claw cracker having a base; a first leg mounted to the base at one end and proceeding outward therefrom; a second leg, pivotally mounted to the base at one end and proceeding outward therefrom; and a meat extractor, mounted to the base and extending perpendicularly outward therefrom.

This, together with other aspects and advantages which will be subsequently apparent, reside in the details of construction and operation as more fully hereinafter described and claimed. Reference will be had to the accompanying drawings forming a part hereof, wherein like numerals refer to like parts throughout.

In a preferred embodiment of the invention, a squid shaped crab claw cracker, comprising a base, a first leg mounted to the base at one end and proceeding outward therefrom, a second leg, pivotally mounted to the base at one end and proceeding outward therefrom, and a meat extractor, mounted to the base and extending perpendicularly outward therefrom.

In a further embodiment of the invention, a squid shaped crab claw cracker, comprising a disk shaped base, a first leg mounted to the base at one end and proceeding outward therefrom, a second leg, pivotally mounted to the base at one end and proceeding outward therefrom, said first and second legs forming a crab cracker, and a meat extractor, mounted to the base and extending perpendicularly outward therefrom.

In still a further embodiment of the invention, a squid shaped crab claw cracker, comprising a disk shaped base, a first leg having serrations mounted to the base at one end and proceeding outward therefrom, a second uniting leg having serrations, pivotally mounted to the base at one end and proceeding outward therefrom, said first and second legs forming a crab cracker, and a meat extractor, mounted to the base and extending perpendicularly outward therefrom.

### BRIEF DESCRIPTION OF THE DRAWINGS

FIG. 1 is a perspective view of a squid shaped crab claw cracker in accordance with the present invention.

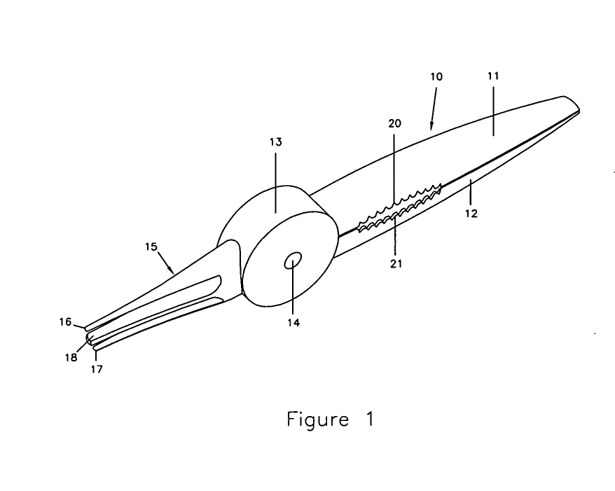

FIG. 2 is a side elevation view of the squid shaped crab claw cracker.

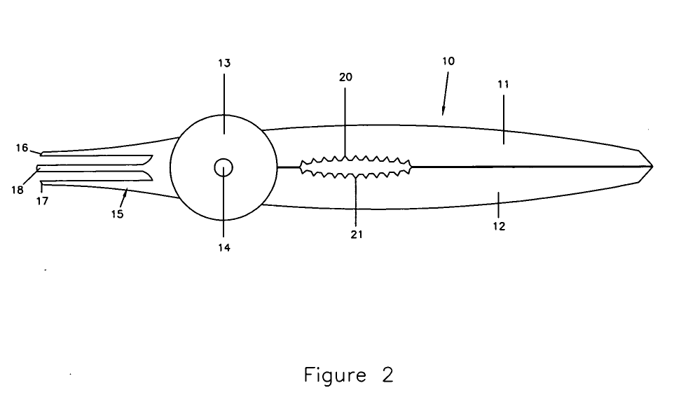

FIG. 3 is a side elevation view of the squid shaped crab claw cracker depicting an open configuration.

### DETAILED DESCRIPTION OF THE PREFERRED EMBODIMENT

Reference will be made in detail to the presently preferred embodiments of the invention, examples of which are illustrated in the accompanying drawings, wherein like reference numerals refer to like elements throughout.

The present invention is directed toward a squid shaped crab claw cracker 10. The squid shaped crab claw cracker 10 includes a first leg 11, a second leg 12, a base 13, and a meat extractor 15. The base is disk shaped.

The first leg 11 is mounted at one end to the base 13 and proceeds outward therefrom. The second leg 12 is pivotally attached at a pivot point 14 to the base 13 and proceeds outward therefrom. A series of ridges 20, 21 are formed into the inside portion of both the first leg 11 and the second leg 12 and are generally in opposition to one another.

A meat extractor 15 is mounted to the base 13 opposite to the first leg 11 and the second leg 12. The meat extractor 15 is generally ‘W’ shaped and is formed with a top blade 16, and a bottom blade 17. A center strip 18 is generally disposed centrally between the top blade 16 and the bottom blade 17. The top blade 16, bottom blade 17, and center 18 are substantially parallel to one another.

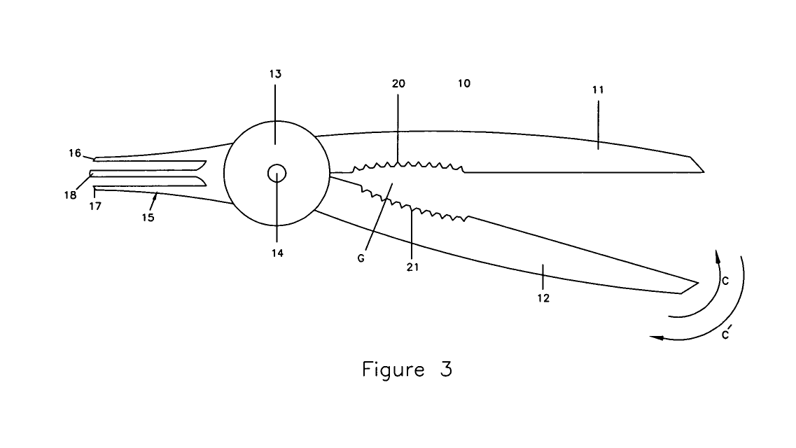

The second leg 12 of the squid shaped crab claw cracker 10 pivots at the pivot point 14 of the base 13. When the second leg 12 of the squid shaped crab claw cracker 10 is open as depicted in FIG. 3, a gap G is formed between the ridges 20 of the first leg 11 and the ridges 21 of the second leg 12. A crab claw (not shown) can be placed in the gap G, and the second leg 12 can be pivoted about the pivot point 14 in the direction of the arc C to crack the crab claw. The second leg 12 can then be pivoted about the pivot point 14 in the direction of the arc C to open or reopen the squid shaped crab claw cracker 10. The legs have serrations.

The meat extractor 15 of the squid shaped crab claw cracker 10 can be inserted into the crab claw by inserting either the top blade 16 or the bottom blade 17 into the crab claw, leveraging them against the center strip 18 and drawing the meat out of the crab claw. Additionally, the top blade 16 or the bottom blade 17 may be used to slice open the shell by leveraging one or the other against the center strip 18 in order to extract the meat. In a preferred embodiment of the present invention, the center strip 18 is flat; however, any shape known to one of ordinary skill in the art may be used for the shape of the center strip 18.

In addition to the embodiments shown in the Figures, the following aspects of the invention are disclosed. The novel squid shaped crab claw cracker disclosed is substantially in the shape of a squid to make a more enjoyable experience while cracking and extracting meat from the squid shaped crab claw cracker. Additionally, the novel squid shaped crab claw cracker includes a meat extractor so that the meat can be extracted from the crab claw immediately after it is cracked.

While the preferred embodiment of the present invention has been described and illustrated, modifications may be made by one of ordinary skill in the art without departing from the true nature and scope of the invention as defined in the appended claims. For example, in a preferred embodiment of the present invention, the squid shaped crab claw cracker is made out of stainless steel; however, any material known to one of ordinary skill in the art may be used to form the squid shaped crab claw cracker, such as plastic, wood, or the like. Additionally, in a preferred embodiment of the present invention, only one leg pivots about the pivot point, however both legs could pivot about the pivot point. A top blade, center blade, and bottom blade comprise the meat extractor; however, any number and configuration of blades known to one of ordinary skill in the art may be used.

The present invention has been described with reference to the above preferred embodiment. The true nature and scope of the invention is to be determined with reference to the attached claims.

1. A squid shaped crab claw cracker, comprising:
a base;
a first leg mounted to the base at one end and proceeding outward therefrom;
a second leg, pivotally mounted to the base at one end and proceeding outward therefrom; and
a meat extractor, mounted to the base and extending perpendicularly outward therefrom.

2. A squid shaped crab claw cracker, comprising:
a disk shaped base;
a first leg mounted to the base at one end and proceeding outward therefrom;
a second leg, pivotally mounted to the base at one end and proceeding outward therefrom, said first and second legs forming a crab cracker; and
a meat extractor, mounted to the base and extending perpendicularly outward therefrom.

3. A squid shaped crab claw cracker, comprising:
a disk shaped base;
a first leg having serrations mounted to the base at one end and proceeding outward therefrom;
a second uniting leg having serrations, pivotally mounted to the base at one end and proceeding outward therefrom, said first and second legs forming a crab cracker; and
a meat extractor, mounted to the base and extending perpendicularly outward therefrom.
